(19) United States
(12) Patent Application Publication
(10) Pub. No.: US 2006/0143957 A1
(43) Pub. Date: Jul. 6, 2006

(54) Mobile display equipment

(76) Inventor: Mahmood Salehi, CHESHIRE (GB)

Correspondence Address: BOOTH UDALL, PLC, 1423 S. HIGLEY ROAD, SUITE 110, MESA, AZ, 85206, US

(21) Appl. No.: 10/544,950

(22) PCT Filed: Feb. 9, 2004
(86) PCT No.: PCT/GB04/00509

§ 371 Date: Aug. 8, 2005

(30) Foreign Application Priority Data
Feb. 7, 2003 (GB) 0302829.7

(51) Int. Cl. G09F 21/04

(52) U.S. Cl. 40/590

(57) ABSTRACT

Advertising or information displays can be shown on screens (10, 11) provided on walls of a van-bodied road vehicle. The displays comprise video or still images back projected onto the screens from projectors (13) located within the vehicle body (1). The projectors (13) have control units (13a) with stored digital image data connected to a local computer unit (14) which operates the projectors. The computer units (14) of different vehicles are connected by wireless links to a central management server (22) which controls operation.

This invention relates to mobile display equipment.

It is well known to install fixed screens in public places for displaying video images for purposes of entertainment, information or advertising. Such screens may be controllable electronic screens, e.g. plasma screens, or projection screens. By appropriate fixed siting and through use of high power equipment good display visibility can be attainable even in daylight conditions.

It is also known to provide external display screens on vehicles which comprise sheet material printed with static images, display changes being effected by moving the sheet to bring different areas of the sheet printed with different images into view. Display equipment of this kind can be conveniently installed as mobile equipment on vehicles and good visibility in daylight conditions can be attained with static printed images, but appeal is limited particularly due to limited possibilities for movement, image change and other video effects.

An object of the present invention is to provide mobile display equipment which can be conveniently installed on a vehicle and with which appealing displays can be readily attained with good visibility.

According to the invention therefore there is provided mobile display equipment comprising at least one screen mounted on a vehicle and having a front surface exposed externally thereof, characterised by the provision of an image generating device operable to generate images on said screen so as to be visible on said front surface.

Preferably the screen has light transmitting properties and the image generating device comprises at least one projection device mounted within the vehicle for projecting images on to the rear of the screen so as to be visible on said front surface thereof.

With the invention it is possible to provide clearly visible appealing displays with equipment which can be readily and conveniently installed in a vehicle so as to be mobile therewith.

With regard to the vehicle, this may be of any suitable kind although it is visualised that the invention may find particular application in the context of a wheeled vehicle, such as a road vehicle or a rail vehicle such as a train or trolley.

Most preferably, the vehicle has a box-structure body, such as a van body of a lorry or other road vehicle of the load-carrying kind, a train body of the goods container kind, a train or trolley carriage or the like, which body has at least one upright wall on or within which the screen is mounted so that the said front surface of the screen is external to the body.

Preferably also, such box-structure body has a plurality of upright walls each with a respective said screen.

Where multiple screens are provided these may be of the same or different sizes, and may have a common said projection device and/or different projection devices one for each screen or otherwise associated with the respective screens.

The (or each) screen preferably comprises a planar body particularly a transparent or translucent planar body capable of providing a high image intensity suitable for viewing in different conditions including bright sunlight.

The planar body may have a thermal expansion ratio which is higher than adjoining materials of the vehicle whereby the screen may be provided with a support structure which supports or suspends the planar body relative to the vehicle in such a manner as to accommodate relative movement therebetween due to differing coefficients of thermal expansion. Preferably the arrangement is such that the planar body remains flat and does not therefore distort the image notwithstanding expansion or contraction of the planar body. Thus, the support structure may comprise a lower track and/or side tracks in which a lower edge and/or side edges of the planar body rests with sufficient freedom to permit expansion or contraction of the planar body relative to the track or tracks. The body may sit freely in the track or tracks or there may be sealing material such as rubber with sufficient flexibility to allow movement.

The (or each) screen may be disposed vertically. Alternatively the (or each) screen may be disposed in upright disposition but at an angle to the vertical. Other arrangements are also possible as desired.

In a particularly preferred arrangement there are three screens applied to a vehicle body (e.g. the aforesaid box-structure body), two respectively on opposite side walls and the third at a rear end wall of the body.

The (or each) aforesaid projection device is preferably located within the vehicle, particularly within the aforesaid vehicle box-structure body. The (or each) projection device is preferably supported or suspended with a suspension system or shock absorbers e.g. including rubber feet to prevent or damp movement, so as to maintain the (or each) projection device and the respective screen in fixed predetermined relationship notwithstanding rapid movements originating from movement of the vehicle and to protect the projection device. Also, circuitry within the (or each) projection device is preferably fixed and supported by means of silicon or other material in order to protect against effects of movement.

Where space requirements are such that the (or each) projection device is mounted relatively close to the respective screen a wide angle lens (e.g. 0.8) may be provided to project an image over all or a substantial part of the screen. The projection device may have its optical axis aligned with the centre of the screen and may be perpendicular to the screen. Alternatively however space requirements may require positioning of the projection device with its optical axis at an angle to the screen and possibly offset from the centre thereof whereby appropriate electronic or other arrangements may be necessary to counter optical distortion arising from this arrangement. Mirrors may be interposed between the projection device and the screen. Also the screen area may be partitioned.

The (or each) projection device is preferably capable of providing sufficient intensity (usually about 4500 or higher ansi lumens) for the image to be visible in ambient conditions including bright sunshine, although a lower intensity may be used for one or more of the screens, e.g. the back screen for safety purposes. The or each projection device may take any suitable form and thus may comprise a bright light source projected through an electronic screen such as an LCD screen. Other arrangements involving film or other electronic devices such as CRT, gas plasma, LCD/DLP projection etc can be used. Also, instead of back projection, front projection or other non-projection techniques such as activation of electronic said screens which may themselves be CRT, gas plasma, LCDS etc may be used.

The (or each) projection device or other image generating device is preferably connected to a computer unit with stored image data. Where multiple image generating devices are provided there may be a common computer unit for all such devices, or a respective unit for each projection device.

The (or each) computer unit may be provided in the aforesaid box-structure body of the vehicle, or externally thereto e.g. in a vehicle driver's cab. Control of the (or each) computer unit may be effected locally thereto, e.g. by a linked keyboard, and/or remotely e.g. by signals transmitted thereto via satellite link or with any other wireless system. The image data may be stored locally e.g. within the (or each) computer unit or an associated data store or medium, and provision may be made for changing such data locally (e.g. by changing storage media) and/or remotely by data transmission i.e. in correspondence with signals from a remote source via a remote transmission link between the source and the computer unit e.g. using mobile wireless network connections.

Although the display equipment may receive signals from a remote source, the arrangement is preferably such that the display equipment is wholly operable in a self contained manner i.e. without requiring an external communication or broadcast streaming link during operation.

Any suitable storage medium may be used including CD-ROM, DVD, VHS etc, although preferably digital storage e.g. on a hard disk or a digital flash card or the like is preferred.

The (or each) image generating device may derive electrical power from the vehicle d.c. power supply with appropriate conversion as required and/or an independent power supply or generator may be provided. Most preferably, all operating power for the display equipment is derived from the vehicle power source and/or from a power source carried by the vehicle so that an external power source is not required.

The (or each) image generating device, particularly in the case of a projection device and/or the (or each) screen is preferably sealed or screened to prevent or limit access thereto of external ambient illumination so far as the projection path between the projection device and rear of the screen is concerned.

With regard to the image this may be a moving video image and/or a fixed still image and/or changing still images (e.g. rapidly changing to simulate movement) for advertising or other purposes. Images may be in colour. Different kinds of images may be provided on different screens. In particular, with the aforesaid arrangement of side and rear screens there may be static images on the rear and moving (video) images on the side screens.

A timed program of images may be used e.g. different images for breakfast, lunch and evening periods.

The display equipment is preferably such that it can be used to provide good quality displays whilst the vehicle is moving. However, in practice the equipment may be used alternatively or additionally when the vehicle is static or even with a body of the vehicle (e.g. the aforementioned box-structure body) within which the equipment is incorporated demounted from the vehicle. The equipment may be permanently or removably installed in the vehicle or body.

In addition to images, the display equipment may also be operable to provide an accompanying audio output e.g. with directional loudspeakers associated with the (or each) screen.

A central management system may be provided to which the display equipment and preferably multiple separate such display equipments of different vehicles are connected for control and monitoring purposes using mobile wireless connectivity and/or network connections with wired Ethernet, optical fibres, Internet via modem or ADSL, satellite or cellular communications or the like.

A GPS tracking system may be used to give vehicle location information to the central management system. Also, security and maintenance information (e.g. lamp life) may be derived e.g. by monitoring equipment or vehicle status, engine switch off, extended periods when the vehicle is stationary, open doors etc.

Communications back to the vehicle e.g. to give route information and/or to access and initiate procedures for the equipment may also be included.

The invention will now be described further by way of example only and with reference to the single figure of the accompanying drawings in which:—

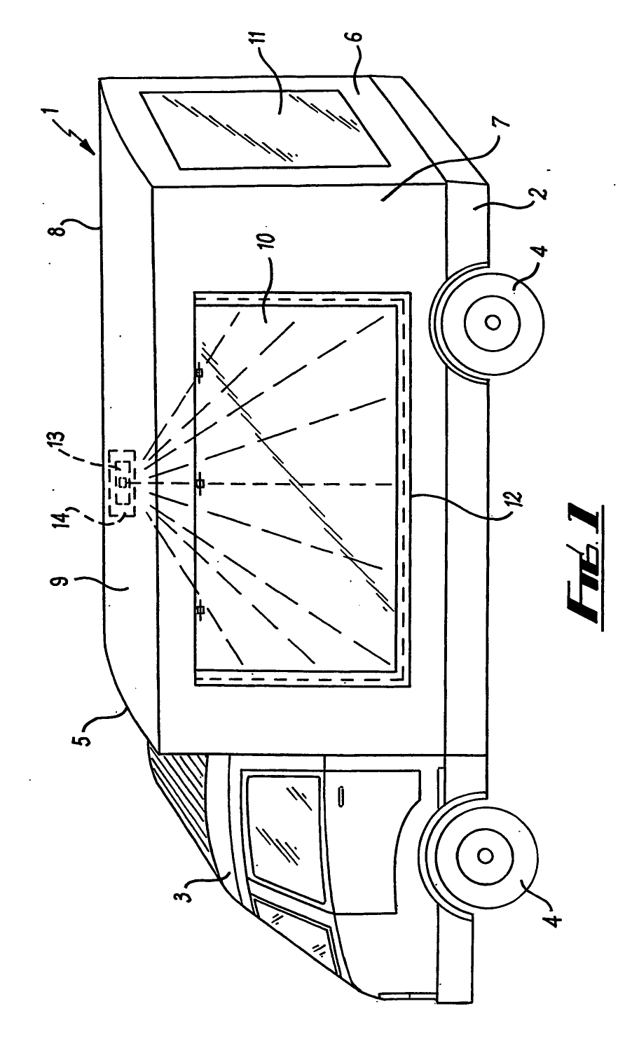

FIG. 1 is a diagrammatic perspective view of one form of mobile display equipment applied to a road vehicle in accordance with the invention;

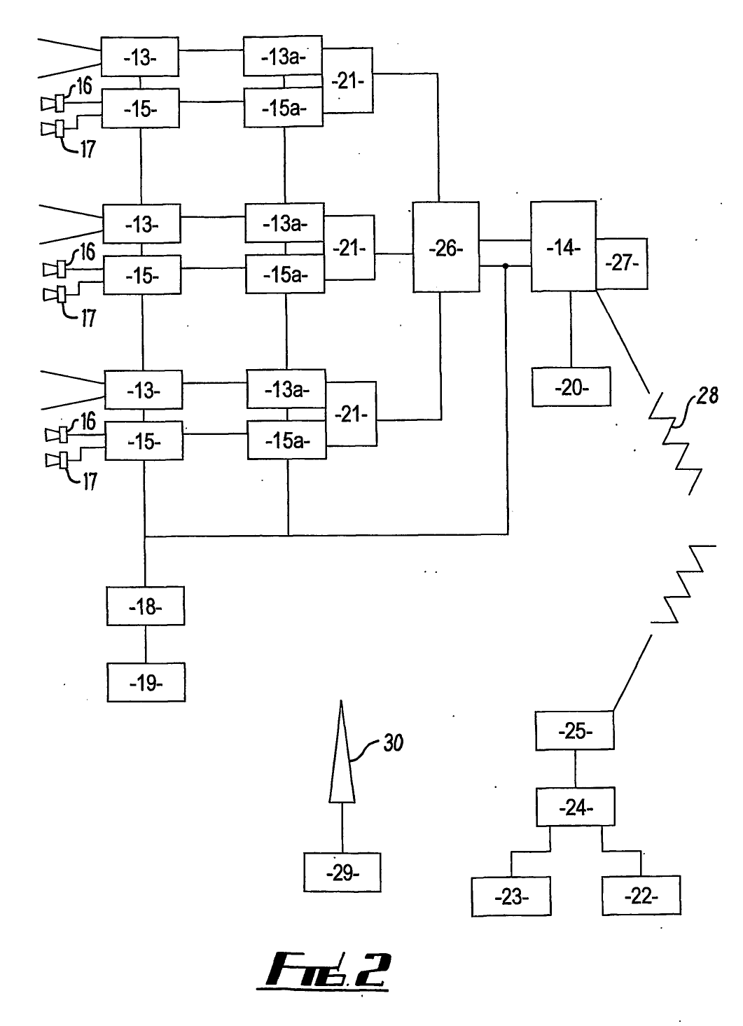

FIG. 2 is a schematic diagram showing a management system for the equipment; and

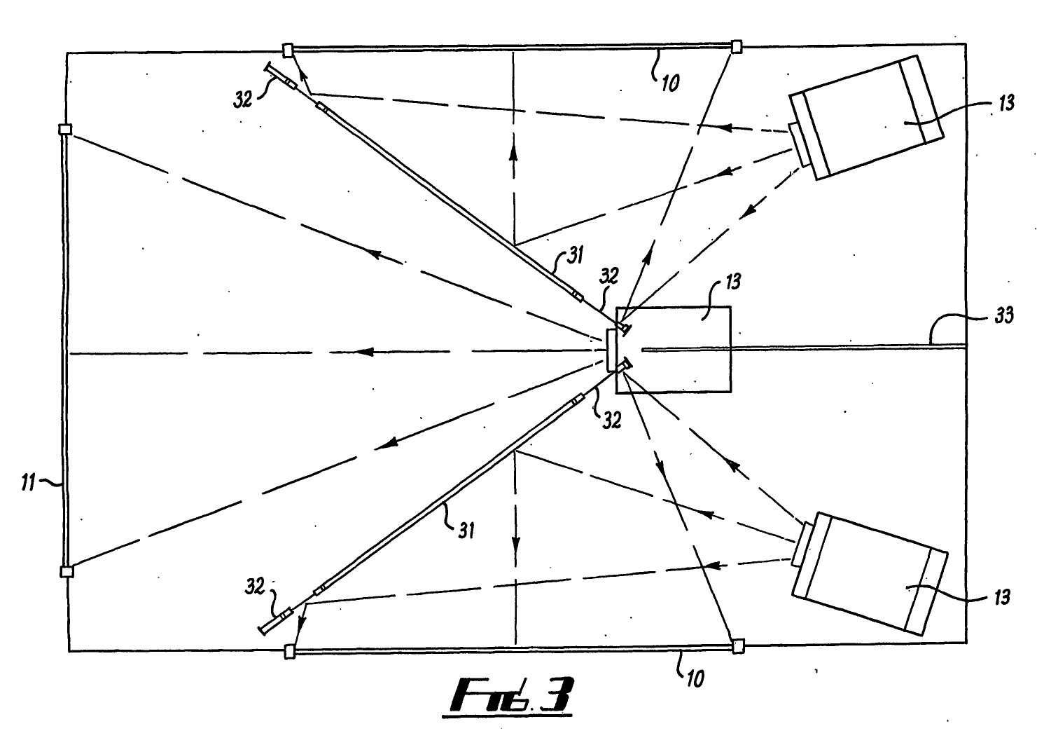

FIG. 3 is a diagrammatic view of a modification of the embodiment of FIG. 1.

FIG. 1 shows a wheeled road vehicle in the form of a lorry having a box-structure van body 1 mounted on a chassis 2 with a front cab 3 and road wheels 4.

The box-structure van body 1 has front and rear end walls 5, 6; opposite side walls 7, 8 and a top wall 9 constructed as panels supported on rigid frames mounted on the chassis 2.

The opposite side walls 7, 8 and the rear end wall 6 are provided with cut out sections into which respective side screens 10 and an end screen 11 are mounted.

The screens 10, 11 comprise planar bodies with flat outer surfaces which are substantially coplanar with the outer surface of the respective walls 6, 7, 8.

The planar bodies of the side screens 10 are both rectangular of the same size. The planar body of the end screen 11 is rectangular and smaller. The planar bodies extend substantially vertically.

Provision is made for entry to the interior of the van body 1 via a door which may be in one of the walls 6, 7, 8 alongside the respective screen 10, 11, or the back wall 8 including the end screen 11 may open to permit entry.

Each planar body of the screens 10, 11 comprises a transparent or translucent rigid or semi-rigid self supporting sheet which is supported within a track 12 which extend continuously along the bottom and upright side edges of the sheet. Suitably, each planar body may be a 5 mm thick darkly translucent polymer sheet.

Each track 12 is fixed to the frame structure of the respective wall 6, 7, 8 around the corresponding edges of the cut out section in the wall 6, 7, 8. Each track 12 is a channel of U-shaped cross-section open upwardly along the bottom edge and inwardly at the side edges.

The planar body of the respective screen 10, 11 fits within the respective track 12 with sufficient freedom to allow movement of the body due to thermal expansion and contraction without physical distortion of the screen yet such as to hold the body securely in position and water tight. The tracks may contain flexible sealing material such as rubber which permits movement.

Within the van body 1 there are mounted three projectors 13, e.g. on brackets beneath the top wall 9 with suspension elements or rubber legs to prevent rapid movement of the projectors relative to the van body 1 due to movement of the vehicle to protect the projector and associated equipment.

The projectors 13 are high intensity (e.g. 4500 or higher ansi lumens) projectors which are respectively positioned to project images on to back surfaces of the three screens 10, 11 within the body 1. The projectors may have a 1:1 lens arrangement and may project directly or via mirrors. Alternatively a wide angle lens e.g. 0.8 may be used. The projectors are colour DLP/LCD projectors which generate images from digital image data or any other digital, analogue, video source.

The projectors 13 are located within the body relative to the screens 10, 11 and by use of screening and sealing the light path between each projector 13 and the corresponding screen within the van body is isolated.

In addition, a sound system is provided which comprises three audio amplifiers 15 connected to three pairs of stereo outdoor directional speakers 16, 17 respectively alongside the three screens 10, 11.

The projectors 13 and audio amplifiers 15 have operating units 13a, 15a which are connected to a computer unit 14 and the computer unit 14, the amplifiers 15, the projectors 13 and the units 13a, 15a are connected to the d.c. output of the vehicle alternator 18 via a power supply circuit or inverter 19 to obtain operating power. The unit 14 may be in the body, or in the vehicle cab, e.g. under the driver's seat.

The computer can be operated by a control device such as a keyboard 20 or the like located within the van body 1 or in the cab 3 or elsewhere as desired. Alternatively or additionally the computer may be controlled remotely e.g. via satellite link to a remote control centre as described hereinafter.

In accordance with appropriate stored data on storage devices 21 (e.g. on CD-ROM DVD or other replaceable medium and/or a hard disk or flash card or other digital storage device) for the units 13a, 15a, the projectors 13 project high intensity images on the rear of the screens 10, 11 to produce images on the front surfaces of the screens which are clearly visible externally of the vehicle even in bright sunshine, and sound is produced through the loudspeakers 16, 17. The components 13a, 15a, 21 for each projector 13 are preferably formed as an integrated unit.

The images may be moving video images or still images which may be fixed or may be changed on a ‘slide-show’ or other basis under local or remote control. Most preferably moving (video) images are produced on the side screens 10 and static images are produced on the rear screen 11, especially when the vehicle is moving. When the vehicle is stationary, the rear screen may show video images.

The images may be of an advertising nature or public information or may be for other purposes.

The computer unit 14 may facilitate changes in the images such that different images are produced at different times in the day e.g. breakfast, lunch and evening periods. Thus there may be a breakfast advertising campaign between 6 am and 11 am, a lunchtime offer between 11 am and 2 pm, alcohol advertising between 7 pm and 2 am. The advertising may comprise a number of sequences shown in a particular order. The same display may be used nationally on a number of vehicles, or displays may be different for different local regions.

As shown in FIG. 2, a management system may be used to control operation of the mobile display equipment for a number of vehicles.

The management system comprises, at a central location a main server 22 and a VPN (virtual private network) server 23 connected to the internet e.g. via a switch 24 and an ADSL router 25.

The three video and audio units 13a, 15a for each vehicle are networked via a hub 26 to the respective computer unit 14 which is configured as a VPN client.

The computer unit 14 is a PC unit which includes digital operating data storage 27 which conveniently may be of the compact flash card kind so that the operating system can be readily updated when required locally or remotely.

The VPN client 14 is connectable to the Internet via a mobile wireless link 28 e.g. using GPRS/GSM mobile telephony or 3G or a wireless network (wi-fi) or the like.

In this way data communication can be established between the computer unit 14 of the mobile display equipment of each vehicle and the server 22 of the central management system.

The display equipment of each vehicle is capable of operating independently of the management system using the video/audio data in the data stores 21 under the control of the operating system of the local PC unit in the data store 27. That is, the equipment can operate without the link 28 being active.

Video and audio procedures may be initiated locally e.g. using the keyboard 20 or in accordance with an automatic program stored in the PC unit store 27 whereby for example, as mentioned above, video displays may be produced on the side screens 10 and a single or changing static display may be produced on the rear screen 11, with associated directional audio through the loud speakers 16, 17. The displays and audio once initiated may loop indefinitely or for set periods. The displays and audio may change at different periods in the day to give displays and audio appropriate e.g. to breakfast, lunch and evening periods.

The static display on the rear screen may be maintained when the vehicle is travelling and may be switchable automatically or when initiated to video when the vehicle is stationary.

By virtue of the communication with the management system, which may be continuous, on demand, or periodically in accordance with a set program, the management system can monitor operation of the equipment of individual vehicles, initiate operational procedures of the equipment, and even update or change stored operational data of the PC unit in the store 27 and/or the stored video and/or audio data in the stores 21.

By use of GPS tracking, data indicating location of each vehicle can be received by the central management system.

Information concerning route changes can be relayed back to the driver of a vehicle via the link between the management system and the local PC unit, and/or via separate mobile phone communications or the like.

Maintenance, security and breakdown or error parameters can be monitored and relayed to the management system so that remedial action can be taken or initiated e.g. by sending alert or information messages via e-mail, SMS, pager or the like.

Other control and management functions can also be implemented.

In addition to Internet communication between each vehicle and the central management system via VPN, provision may be made for local wireless communication e.g. when the vehicle enters a depot which is provided with a local control system 29 and a wireless access point 30.

In this case, the wireless communication link of the vehicle used to establish wireless internet connection may connect instead with the local wireless access point 29. Alternatively, a separate wireless connection point in the vehicle may come into operation. This may occur automatically when the vehicle comes into range of the local access point, or may be initiated e.g. via the keyboard or other manual control device.

This localised wireless connection may be used in substitution for the Internet connection with the management system and/or may be used for different purposes e.g. for high rate transfer of data e.g. to change or update the video/audio data.

The localised control system 29 may be stand alone or may be linked to the central management system or may be a mobile computer unit with a wireless connectivity.

With the invention clear appealing images can be displayed in a mobile environment using equipment which is convenient to install and use.

It is of course to be understood that the invention is not intended to be restricted to the details of the above embodiment which are described by way of example only.

Thus for example, although FIG. 1 indicates a direct projection path between the projectors 13 and the screens 10, 11, in practice, as shown in FIG. 3, mirrors 31 are preferably provided, at least between the two side screens 10 and the respective projectors 13 so that an adequate light path to encompass the entire screen can be achieved in the space available. The mirrors 31 are provided with support frames 32. The area around the mirrors 31 may be partitioned essentially floor to ceiling and this, together with a central rear partition 33 shields each screen 10, 11 from light entering through other screens.

The projector 13 for the rear screen 11 can be mounted above or below the mirrors 31 at a suitable small angle to provide the image on the rear screen 11.

Also, the display equipment described may be used in contexts other than vehicle van bodies; it may be used in other vehicles or even in other non-vehicular housings. Also, whilst the back-projection display format is preferred other kinds of display equipment may alternatively be used. In particular; in accordance with a further aspect of the invention images may be displayed externally of a vehicle body on one or more controlled screens having outer display surfaces directed externally of the vehicle body (as described above in connection with the back-projection aspect), which screen (or screens) are electronic controlled screens such as plasma, LCD, OLED or the like. Moreover, the images displayed in either aspect of the invention may be holographic or of any other form.

1. Mobile display equipment comprising at least one screen mounted on a vehicle and having a front surface exposed externally thereof characterised by the provision of an image generating device operable to generate images on said screen so as to be visible on said front surface.

2. Mobile display equipment to of claim 1 characterised in that the screen has light transmitting properties and the image generating device comprises at least one projection device mounted within the vehicle for projecting images on to the rear of the screen.

3. Mobile display equipment of claim 1 characterised in that the vehicle is a wheeled road vehicle.

4. Mobile display equipment of any one of claims 1 characterised in that the vehicle has a box-structure body with at least one upright wall on or within which the t said screen is mounted so that the front surface of the screen is external to the body.

5. Mobile display equipment of claim 4 characterised in that the body has a plurality of upright walls each with a respective said screen.

6. Mobile display equipment of claim 5 characterised in that there are two screens respectively on opposite side walls and a further screen at a rear end wall of the body.

7. Mobile display equipment of claims 4 characterised in that the (or each) screen comprises a planar body provided with a support structure which supports or suspends the planar body relative to the vehicle such as to accommodate relative movement therebetween due to differing coefficients of thermal expansion.

8. Mobile display equipment of claim 7 characterised in that the support structure comprises tracks in which edges of the planar body sit with sufficient freedom to permit expansion or contraction relative thereto.

9. Mobile display equipment of claim 2, wherein the vehicle has a box-structure body with at least one upright wall on or within which the t said screen is mounted so that the front surface of the screen is external to the body, and wherein the at least one projection device is located within the box-structure body.

10. Mobile display equipment of claim 1 characterised in that the images include moving images.

11. Mobile display equipment of claim 10 characterised in that the images also include static images.

12. Mobile display equipment of claim 6 wherein the images also include static images generated on the rear screen and moving images on the side screen.

13. Mobile display equipment of claim 1 characterised by the provision of a computer unit for controlling operation of the image generating device with image data in a data store.

14. Mobile display equipment of claim 1 characterised by the provision of at least one audio device arranged to produce an audio output associated with the at least one screen.

15. Mobile display equipment according to of claim 14, wherein the computer unit also controls operation of the audio device with audio data in the data store.

16. Mobile display equipment of claim 13 characterised by the provision of a management system having a server (22) at a remote location, the computer unit being connectable to the server via a wireless link for communication therebetween.

17. A mobile display network comprising a plurality of mobile display equipments, each mobile display equipment comprising at least one screen mounted on a vehicle and having a front surface exposed externally thereof characterised by the provision of an image generating device operable to generate images on said screen so as to be visible on said front surface, and a computer unit for controlling operation of the image generating device with image data in a data store, and the mobile display network further comprising a management system having a common server at a remote location, the computer units of the respective equipments being connectable to the common server via wireless links for communication therebetween.

18. The mobile display network of claim 17, wherein each mobile display equipment further comprises at least one audio device arranged to produce an audio output associated with the at least one screen.

19. The mobile display network of claim 18, wherein the computer unit of each mobile display equipment also controls operation of the at least one audio device with audio data in the data store
